(19) United States
(12) Patent Application Publication
(10) Pub. No.: US 2007/0125559 A1
(43) Pub. Date: Jun. 7, 2007

(54) Quick replacement device for digging and weeding tools

(76) Inventor: Shih-Hao Hus, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/284,361

(22) Filed: Nov. 22, 2005

(51) Int. Cl. A01B 3/02

(52) U.S. Cl. 172/354

(57) ABSTRACT

A quick replacement device for digging and weeding tools includes a hollow mounting tube, and a drive tube mounted in the mounting tube. The support seat of each of the weeding tool and the digging tool has a mediate portion formed with an open slot. The drive tube is inserted into the open slot of the support seat, and the push block of the drive tube is protruded from the support seat. Thus, the drive tube is detachable from the open slot, so that the support seat is removable from the flat bracket for replacement of the weeding tool or the digging tool without having to detach the push block from the drive tube, thereby facilitating the user replacing the weeding tool and the digging tool, and thereby preventing the push block from being lost.

### BACKGROUND OF THE INVENTION

1. Field of the Invention

The present invention relates to a quick replacement device and, more particularly, to a quick replacement device for digging and weeding tools.

2. Description of the Related Art

A conventional quick replacement device for digging and weeding tools in accordance with the prior art shown in FIG. 3 comprises a hollow mounting tube 11, and a drive tube 12 mounted in the mounting tube 11. A circular push block 14 is locked onto a front end of the drive tube 12, and a circular push knob 15 is locked onto a rear end of the drive tube 12. The mounting tube 11 has a front end provided with a flat bracket 13 by soldering. The flat bracket 13 has two screw bores 16 formed in two ends thereof for locking a weeding tool 20 or a digging tool (not shown) by two bolts 17 and two nuts 18. The weeding tool 20 includes a support seat 21 having two screw bores 19 formed in two ends thereof for locking the support seat 21 to the flat bracket 13 by the two bolts 17 and the two nuts 18. The support seat 21 has a mediate portion formed with a through hole 22 to allow passage of the front end of the drive tube 12 for locking the push block 14.

However, when the user wishes to replace the weeding tool 20 or the digging tool, he has to unscrew the two bolts 17 and the two nuts 18 and to remove the push block 14 from the drive tube 12 for replacement of the weeding tool 20 or the digging tool, thereby causing inconvenience to the user. In addition, the push block 14 is easily lost after the push block 14 is removed from the drive tube 12. Further, the push block 14 is easily rusted during a long-term utilization, so that the push block 14 cannot be removed from the drive tube 12 easily.

### SUMMARY OF THE INVENTION

In accordance with the present invention, there is provided a quick replacement device, comprising a hollow mounting tube, and a drive tube mounted in the mounting tube. The drive tube has a front end provided with a circular push block, and a circular push knob is locked onto a rear end of the drive tube. The mounting tube has a front end provided with a flat bracket. The flat bracket has a mediate portion formed with a circular hole. The flat bracket has two screw bores formed in two ends thereof for locking a weeding tool or a digging tool by two bolts and two nuts. The weeding tool includes a support seat, and two U-shaped teeth secured on the support seat by soldering. The digging tool includes a support seat, and two semi-circular blades secured on the support seat. The support seat of each of the weeding tool and the digging tool has two screw bores formed in two ends thereof for locking the support seat of each of the weeding tool and the digging tool to the flat bracket by the two bolts and the two nuts. The support seat of each of the weeding tool and the digging tool has a mediate portion formed with an open slot. The drive tube is inserted into the open slot of the support seat of each of the weeding tool and the digging tool, and the push block is protruded from the support seat of each of the weeding tool and the digging tool.

The primary objective of the present invention is to provide a quick replacement device for digging and weeding tools.

Another objective of the present invention is to provide a quick replacement device, wherein the drive tube is detachable from the open slot of the support seat, so that the support seat is removable from the flat bracket for replacement of the weeding tool or the digging tool without having to detach the push block from the drive tube, thereby facilitating the user replacing the weeding tool and the digging tool, and thereby preventing the push block from being lost.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a quick replacement device in accordance with the preferred embodiment of the present invention.

FIG. 2 is an exploded perspective view of the quick replacement device as shown in FIG. 1.

FIG. 3 is an exploded perspective view of a conventional quick replacement device in accordance with the prior art.

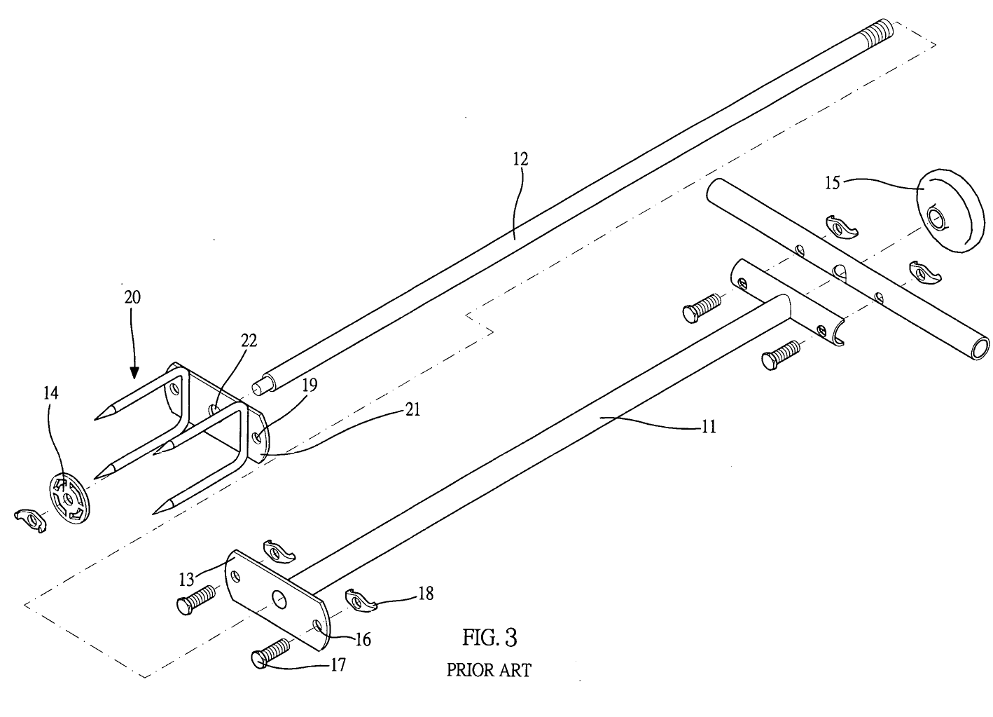

### DETAILED DESCRIPTION OF THE INVENTION

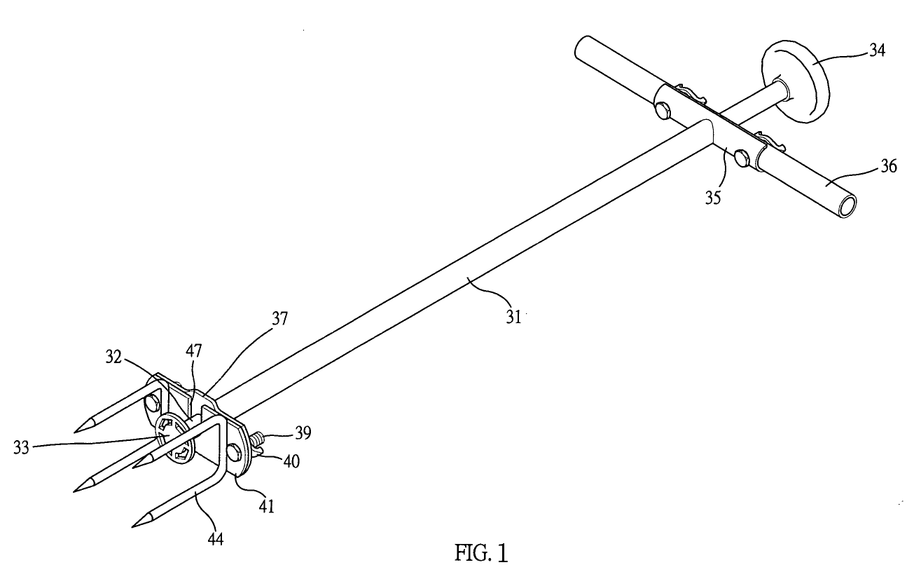

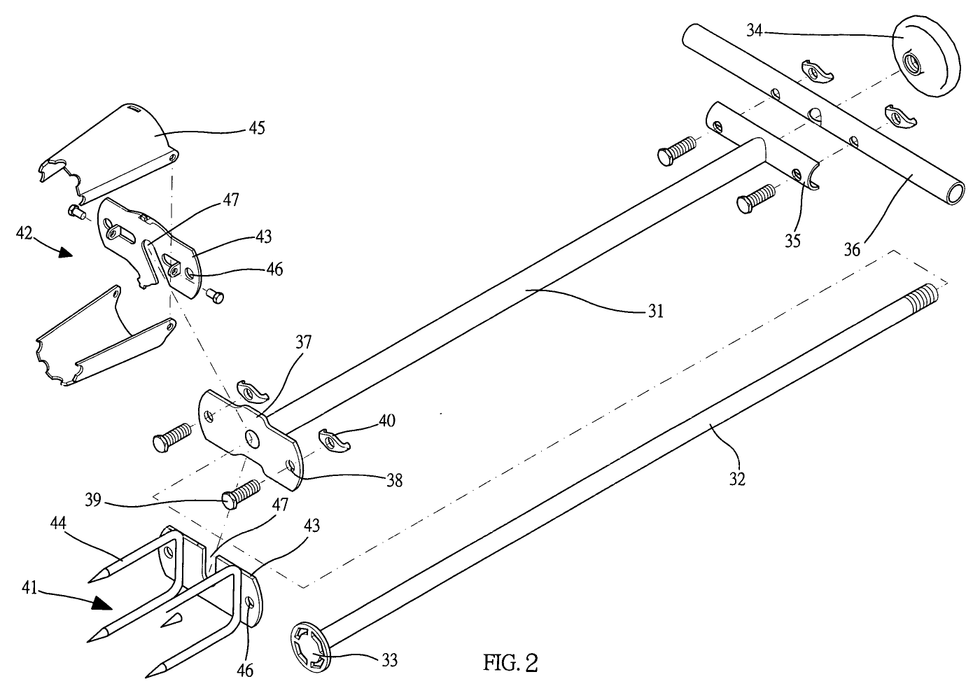

Referring to FIGS. 1 and 2, a quick replacement device in accordance with the preferred embodiment of the present invention comprises a hollow mounting tube 31, and a drive tube 32 mounted in the mounting tube 31.

The drive tube 32 has a front end provided with a circular push block 33, and a circular push knob 34 is locked onto a rear end of the drive tube 32. The mounting tube 31 has a front end provided with a flat bracket 37 by soldering and a rear end provided with a recessed support bracket 35 for locking a handle 36. The flat bracket 37 has two screw bores 38 formed in two ends thereof for locking a weeding tool 41 or a digging tool 42 by two bolts 39 and two nuts 40. The weeding tool 41 includes a support seat 43, and two U-shaped teeth 44 secured on the support seat 43 by soldering. The digging tool 42 includes a support seat 43, and two semi-circular blades 45 secured on the support seat 43. The support seat 43 of each of the weeding tool 41 and the digging tool 42 has two screw bores 46 formed in two ends thereof for locking the support seat 43 of each of the weeding tool 41 and the digging tool 42 to the flat bracket 37 by the two bolts 39 and the two nuts 40. The support seat 43 of each of the weeding tool 41 and the digging tool 42 has a mediate portion formed with an open slot 47 which is a straight slot or an oblique slot.

In assembly, when the support seat 43 of each of the weeding tool 41 and the digging tool 42 is mounted on the flat bracket 37, the drive tube 32 is inserted into the open slot 47 of the support seat 43 of each of the weeding tool 41 and the digging tool 42, and the push block 33 is protruded from the support seat 43 of each of the weeding tool 41 and the digging tool 42.

In operation, the handle 36 is pushed forward by a user, and the flat bracket 37 is stepped by the user's one foot, so that the weeding tool 41 is operated to perform the weeding work or the digging tool 42 is operated to perform the digging work. After the work is finished, the drive tube 32 is pushed forward by the push knob 34 to drive the push block 33 to push out the residual grass or earth deposited in the weeding tool 41 or the digging tool 42.

In replacement, after the two bolts 39 and the two nuts 40 are unscrewed from the support seat 43 and the flat bracket 37, the drive tube 32 is detached from the open slot 47 of the support seat 43 to remove the support seat 43 from the flat bracket 37 for replacement of the weeding tool 41 or the digging tool 42 without having to detach the push block 33 from the drive tube 32, thereby facilitating the user replacing the weeding tool 41 and the digging tool 42, and thereby preventing the push block 33 from being lost.

Accordingly, the drive tube 32 is detachable from the open slot 47 of the support seat 43, so that the support seat 43 is removable from the flat bracket 37 for replacement of the weeding tool 41 or the digging tool 42 without having to detach the push block 33 from the drive tube 32, thereby facilitating the user replacing the weeding tool 41 and the digging tool 42, and thereby preventing the push block 33 from being lost.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A quick replacement device, comprising a hollow mounting tube, and a drive tube mounted in the mounting tube, wherein:
the drive tube has a front end provided with a circular push block, and a circular push knob is locked onto a rear end of the drive tube;
the mounting tube has a front end provided with a flat bracket, the flat bracket has a mediate portion formed with a circular hole, the flat bracket has two screw bores formed in two ends thereof for locking a weeding tool or a digging tool by two bolts and two nuts;
the weeding tool includes a support seat, and two U-shaped teeth secured on the support seat by soldering;
the digging tool includes a support seat, and two semi-circular blades secured on the support seat;
the support seat of each of the weeding tool and the digging tool has two screw bores formed in two ends thereof for locking the support seat of each of the weeding tool and the digging tool to the flat bracket by the two bolts and the two nuts;
the support seat of each of the weeding tool and the digging tool has a mediate portion formed with an open slot;
the drive tube is inserted into the open slot of the support seat of each of the weeding tool and the digging tool, and the push block is protruded from the support seat of each of the weeding tool and the digging tool.

2. The quick replacement device in accordance with claim 1, wherein the open slot of the support seat of each of the weeding tool and the digging tool is a straight slot or an oblique slot.
